(19) United States
(12) Patent Application Publication
(10) Pub. No.: US 2003/0221330 A1
(43) Pub. Date: Dec. 4, 2003

(54) Plastic granule dryer system

(76) Inventor: Bryan Arnold, Elkmont, AL (US)

Correspondence Address: TAYLOR & AUST, P.C., 142 S. Main St., P.O. Box 560, Avilla, IN, 46710, US

(21) Appl. No.: 10/160,647

(22) Filed: May 31, 2002

(51) Int. Cl. F26B 17/24

(52) U.S. Cl. 34/58

(57) ABSTRACT

A drying apparatus which prepares granulated plastic for an injection molding machine, including a centrifugal apparatus configured for receiving the granulated plastic therein, at least a portion of the centrifugal apparatus being configured to rotate and thereby impart centrifugal force upon the granulated plastic and a dry air distributor fluidly coupled with the centrifugal apparatus and configured to deliver dry air within the centrifugal apparatus.

### BACKGROUND OF THE INVENTION

1. Field of the Invention

The present invention relates to a method and apparatus to dry granular plastic, and, more particularly, to a method and apparatus to dry granulated plastic for use in an injection molding machine.

2. Description of the Related Art

There are two basic types of plastic: thermosetting, which cannot be resoftened after being subjected to heat and pressure; and thermoplastic, which can be repeatedly softened and remolded by heat and pressure. When heat and pressure are applied to a thermoplastic binder, the chainlike polymers slide past each other, giving the material plasticity. However, when heat and pressure are initially applied to a thermosetting binder, the molecular chains become cross-linked, thus preventing any slippage if heat and pressure are reapplied.

While plastics are available in the form of bars, tubes, sheets, coils and blocks and these can be fabricated to various specifications, plastic articles are commonly manufactured from plastic powders or granules in which desired shapes are fashioned by compression, transfer, extrusion or injection molding. Granulized plastic is the industrial standard method for the delivery of raw plastic to plastic molding facilities. In compression molding, powdered plastic is generally placed immediately in mold cavities, where the application of heat and pressure makes the material first plastic, then hard. Transfer molding, in which plastic granules are plasticized by outside heating and then poured into a mold to harden, is used for designs with intricate shapes and great variations in wall thickness. Extrusion molding employs a heating cylinder, pressure and an extrusion die through which molten plastic is sent and from which it exits in continuous form to be cut in lengths or coiled. Injection-molding machinery melts the plastic granules in a heating chamber and uses plunger action to force the molten plastic into cold molds, where the plastic hardens.

To provide repeatable results the operations take place at rigidly controlled material temperatures, pressures, molding temperatures, intervals and material content. Moisture in the plastic material disrupts the process and results in an inferior product. Control of the contents of the plastic granules is provided by the manufacturer of the granule, however the absorption of atmospheric moisture by the plastic granules is sufficient to degrade the molding process. To reduce the problems caused by moisture in the plastic material, the plastic granules are dried before being used in an injection molding operation. The drying methods employed utilize the circulation of heated air and/or the use of desiccants. Such methods normally take hours to dry plastic granules and they expend a significant amount of energy.

What is needed in the art is an apparatus which shortens the drying time of plastic granules and results in reduced energy usage.

### SUMMARY OF THE INVENTION

The present invention provides a drying system including a centrifugal apparatus and an air drying system which together efficiently dry plastic granules.

The invention comprises, in one form thereof, a drying apparatus which prepares granulated plastic for an injection molding machine, including a centrifugal apparatus configured for receiving the granulated plastic therein, at least a portion of the centrifugal apparatus being configured to rotate and thereby impart centrifugal force upon the granulated plastic and a dry air distributor fluidly coupled with the centrifugal apparatus and configured to deliver dry air within the centrifugal apparatus.

An advantage of the present invention is that the drying of plastic granules is accomplished in less time than with conventional methods.

Another advantage is less energy is required to dry plastic granules as compared to conventional methods.

Yet another advantage is fewer drying units are needed in a facility since the cycle time to dry plastic granules is reduced.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, which is a schematic view of one embodiment of a plastic granule dryer of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Referring now to the drawing, there is shown a plastic granule dryer 10 which generally includes material insertion device 12, an air drying system 14, a dried material collector 16, a control system 18 and a centrifugal apparatus 20.

Material insertion device 12 includes a supply tube 22 and a material distributor 24. Material insertion device 12 is coupled to a supply of granulated plastic having either a gravity feed with a control gate or a controllable drive for the delivery of granulated plastic to centrifugal apparatus 20. Supply tube 22 is coupled to the supply of granulated plastic and connects to material distributor 24. Material distributor 24 has one end connected to supply tube 22 to receive granulated plastic therefrom. An other end of material distributor 24 is arranged to deliver granulated plastic to centrifugal apparatus 20.

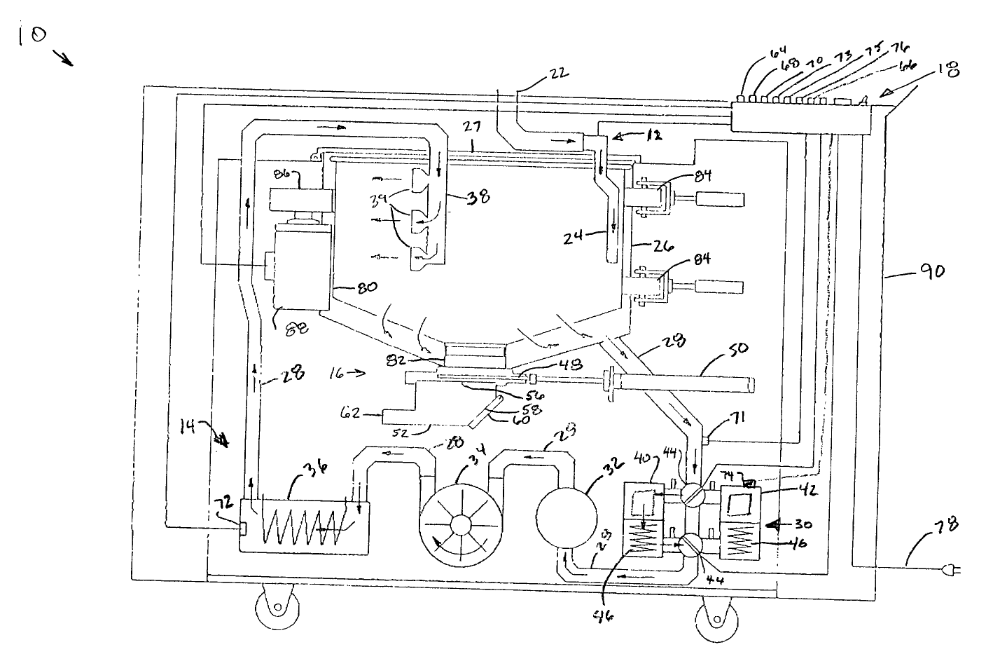

Air drying system 14 includes an enclosure 26, air tubes 28, a desiccant system 30, a filter 32, a blower 34, a heat chamber 36 and an air distributor 38. Air drying system 14 removes air from enclosure 26 and routes it by way of air tubes 28 through desiccant system 30, filter 32, blower 34, heat chamber 36 and air distributor 38 back to enclosure 26. As air is routed through air drying system 14 moisture is removed from the granulated plastic and absorbed in desiccant system 30. Even though the elements of air drying system 14 are shown in a particular order in FIG. 1 the ordering of the elements can be altered. Arrows in FIG. 1 indicate a direction of airflow in plastic granule dryer system 10.

Enclosure 26 surrounds at least a portion of centrifugal apparatus 20 in order to allow the capture of air that has removed moisture from the granulated plastic. Enclosure 26 may optionally include a lid 27 allowing access to the interior thereof by an operator.

Desiccant system 30 includes a first dryer bed 40, a second dryer bed 42, directing valves 44 and desiccant dryers 46. First dryer bed 40 and second dryer bed 42 are each desiccant containers which contain removable desiccant, configured for the passage of air and the absorption of water therefrom. Both first dryer bed 40 and second dryer bed 42 have an air inlet passage and an air outlet passage which are coupled to directing valves 44. Directing valves 44 are coupled to air tubes 28 to receive air therefrom and to exhaust air thereto. Directing valves 44 may be servo operated and are synchronized to allow the passage of air through either first dryer bed 40 or second dryer bed 42 allowing one of dryer beds 40 or 42 to be off-line and one to be on-line at any particular time. Directing valves 44 are interconnected with, and controlled by, control system 18. A desiccant dryer 46 is associated with each of dryer beds 42 and 44. Desiccant dryers 46 provide for the dehydration of dryer beds 42 and 44 when off-line. The dehydration cycle and detection of moisture in dryer beds 40 and 42 is directed by control system 18.

Filter 32 is interconnected with the air flow of air drying system 14 by way of air tubes 28. Filter 32 contains a replaceable element which filters airborne particles from the air directed therethrough.

Blower 34 is an enclosed blower with an air inlet and exhaust, each coupled to air tubes 28 for forcing air throughout air drying system 14. Blower 34 includes an electric motor for the driving of an impeller blade. The speed at which blower 34 operates and the duration thereof is controlled by control system 18.

Heat chamber 36 has an air inlet and an air outlet, each coupled to air tubes 28 for the directing of air therethrough. An electrical element within heat chamber 36 provides heat which is conducted to the air passing through heat chamber 36. The heat output of heat chamber 36 is controlled by control system 18.

Air distributor 38 is connected at one end to an air tube 28 through which dried, heated, pressurized air is supplied. Air distributor 38 has nozzles 39 within enclosure 26 which direct air toward plastic granules disposed on an interior surface of centrifugal apparatus 20.

Dried material collector 16 includes gate 48, air cylinder 50 and enclosure 52. Dried material collector 16 is located beneath centrifugal apparatus 20 for the collection of dried granulated plastic therefrom. Gate 48 seals enclosure 26 from enclosure 52 and prevents granulated plastic from entering enclosure 52 until gate 48 is opened. Air cylinder 50 is attached to a stationary portion of plastic granulate dryer 10 having an extendable/retractable cylinder attached to gate 48. Air cylinder 50 is controlled by control system 18 which provides for the controlled opening of gate 48.

Enclosure 52 includes a collection opening 56, a cleanout opening 58, a cleanout door 60 and a material discharge opening 62. Collection opening 56 is located on the upper portion of enclosure 52 for the purpose of passing granulated plastic from centrifugal apparatus 20 into dried material collector 16 when gate 48 is open. Cleanout opening 58 is provided for the convenience of an operator for cleaning purposes. Cleanout opening 58 is normally covered by cleanout door 60 which is hingedly secured to enclosure 52. Material discharge opening 62 allows for the delivery of dried granulated plastic to a plastic molding machine. The transfer of dried granulated plastic, through material discharge opening 62, is accomplished either by way of a mechanical system, such as an auger, or by way of a vacuum system (not illustrated in the drawings).

Control system 18 includes a material delivery control 64, a centrifugal apparatus speed control 66, a duration control 68, a humidity control 70, a humidity sensor 71, a temperature sensor 72, a temperature control 73, a desiccant sensor 74, a desiccant control 75, blower speed control 76 and an electrical power connection 78. Material delivery control 64 controls the flow of granulated plastic through material insertion device 12 into centrifugal apparatus 20. Centrifugal apparatus speed control 66 controls the speed at which centrifugal apparatus 20 operates. Duration control 68 allows for preset timed operation of plastic granule dryer 10. Humidity sensor 71 senses the humidity of the air after passing over the granulated plastic in air drying system 14 and humidity control 70, which is coupled to humidity sensor 71, stops the operation of plastic granule dryer 10 when an operator predetermined humidity level is achieved. Temperature sensor 72 senses the temperature of heat chamber 36 and temperature control 73, which is coupled to temperature sensor 72, controls the temperature thereof. Desiccant sensor 74 senses the moisture contained in desiccant system 30 and desiccant control 75, which is coupled to desiccant sensor 74, and causes directing valves 44 to redirect air flow when the moisture exceeds an operator determined value. Blower speed control 76 allows the operator to control the speed of blower 34. Electrical power connection 78 supplies electrical power to control system 18 and to all of plastic granule dryer 10. Control system 18 allows an operator the ability to control each function manually or each function may be set to predetermined values.

Centrifugal apparatus 20 includes perforated drum 80, bearing block 82, guide wheels 84, drive wheel 86 and drive motor 88. Centrifugal apparatus 20 processes granulated plastic in a batch operation manner. Granulated plastic enters centrifugal apparatus 20 by way of material distributor 24, and centrifugal force is imparted to the granulated plastic as heated, dried, pressurized air is directed at the granulated plastic by way of air distributor 38. Air flows around the plastic granules and then the air passes through perforated drum 80 and then through the rest of air drying system 14.

Perforated drum 80 is generally cylindrical in shape having a funnel-shaped portion disposed toward the bottom thereof with an opening to allow dried granulate plastic to exit perforated drum 80. Perforated drum 80 has small holes throughout the cylindrical portion and optionally along the funnel-shaped portion. The small holes in perforated drum 80 are sized to prevent the granulate plastic from passing therethrough and formed to prevent the granulate plastic from blocking the small holes. Perforated drum 80 is disposed within enclosure 26 having bearing block 82 attached thereto which allows rotational movement thereof. Perforated drum 80 rotates around a vertical axis and is constrained by bearing block 82, guide wheels 84 and drive wheel 86.

Bearing block 82 constrains perforated drum 80 to rotate about an axis perpendicular to the plane in which bearing block 82 lies. An opening is provided in the center of bearing block 82 to allow granulate plastic to flow from perforated drum 80 to dried material collector 16 when gate 48 is open.

Guide wheels 84 and drive wheel 86 serve to provide dynamic stability to perforated drum 80 while it rotates. Guide wheels 84 also provides an offsetting lateral force from the force of drive wheel 86 which is in frictional contact with an outer surface of perforated drum 80. Guide wheels 84 are secured to a stationary member of plastic granulate dryer 10. Alternatively, guide wheels 84 and drive wheel 86 may be mounted to an inner surface of enclosure 26.

Drive wheel 86 is in frictional contact with an external surface of perforated drum 80. A shaft of drive motor 88 is secured to the center of drive wheel 86. Alternatively, a belt, gear, pneumatic or fluid drive may be used instead of drive wheel 86.

Drive motor 88 is secured to plastic granulate dryer 10, having a shaft coupled to drive wheel 86. Control system 18 is coupled with drive motor 88 to control the speed of drive motor 88 and thus the rotational speed of perforated drum 80.

Plastic granule dryer system 10 is located on a cart 90 to be relocatable relative to plastic injection molding machines (not shown). Alternatively, plastic granule dryer system 10 may be stationary with the dried granulate plastic being delivered to plastic injection molding machines.

The batch drying of granulate plastic is controlled by an operator selecting drying parameters on control system 18 to control the delivery of plastic granules, the rotational speed of perforated drum 80, the desired humidity, the temperature of the air used in the drying process and the speed of the air delivered from blower 34. A measured amount of granulate plastic enters plastic granule dryer system 10 by way of material insertion device 12 and is distributed along a wall of perforated drum 80 as it is spinning. Centrifugal force keeps the granulated plastic on the walls of perforated drum 80.

Air from enclosure 26 is drawn, by way of air tubes 28, in the direction indicated by the arrows in FIG. 1, to desiccant system 30 where moisture is removed from the air. The dried air is routed through air filter 32 and blower 34 to heat chamber 36 where the dried air is heated to enhance its moisture removing ability. The dried heated air is then routed through the shell of enclosure 26 and directed toward the granulated plastic disposed on the inside surface of perforated drum 80. The centrifugal force acting on the granulated plastic serves to drive moisture therefrom, thereby increasing the efficiency of the moisture removal process. As the dried heated air encounters the granulated plastic, moisture is removed therefrom and the continuous air cycle continues until an operator intervenes or until an operator selected duration is completed or until an operator selected humidity level is achieved.

Once the drying cycle is complete the rotation of perforated drum 80 is stopped and the granulated plastic gathers at the bottom of perforated drum 80. Gate 48 is opened and the granulated plastic falls into dried material collector 16 and is therefrom distributed to a plastic molding machine.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drying apparatus for preparing granulated plastic for an injection molding machine, comprising:
a centrifugal apparatus configured for receiving the granulated plastic therein, at least a portion of said centrifugal apparatus being configured to rotate and thereby impart centrifugal force upon the granulated plastic; and
a dry air distributor fluidly coupled with said centrifugal apparatus and configured to deliver dry air within said centrifugal apparatus.

2. The apparatus of claim 1, further comprising an air drying system collecting air from said centrifugal apparatus and expelling air from said dry air distributor onto the granulated plastic.

3. The apparatus of claim 2, wherein said air drying system comprises
a plurality of air tubes;
a desiccant drying system fluidly coupled to at least two of said plurality of air tubes;
a blower fluidly coupled to at least two of said plurality of air tubes; and
a heater fluidly coupled to at least two of said plurality of air tubes.

4. The apparatus of claim 3, further comprising a control system coupled with each of said desiccant drying system, said blower and said heating chamber.

5. The apparatus of claim 4, wherein said control system controls at least one of humidity of air, temperature of air, pressure of air and a rotational speed of said centrifugal apparatus.

6. The apparatus of claim 1, wherein said dry air distributor includes at least one nozzle attached thereto directing air towards the granulated plastic.

7. The apparatus of claim 1, wherein said centrifugal apparatus includes a perforated drum configured to rotate about a substantially vertical axis.

8. The apparatus of claim 7, further comprising an enclosure which at least partially surrounds said perforated drum.

9. The apparatus of claim 7, further comprising an electric motor driving said perforated drum at a selected rate of rotation.

10. A method of drying plastic granules for use in an injection molding machine, comprising the steps of:
introducing plastic granules into a plastic granule drying system comprising:
a centrifugal apparatus configured for receiving the plastic granules therein, at least a portion of said centrifugal apparatus being configured to rotate; and
a dry air distributor fluidly coupled with said centrifugal apparatus and configured to deliver dry air within said centrifugal apparatus; and
applying centrifugal force to said plastic granules by rotating at least a portion of said centrifugal apparatus.

11. The method of claim 10, further comprising the step of directing dried air toward said plastic granules.

12. The method of claim 10, further comprising the steps of:
selecting drying parameters of at least one of a rotational speed for said centrifugal apparatus, duration of a centrifugal cycle, desired humidity, temperature and blower speed; and
controlling said drying parameters.

13. The method of claim 10, further comprising the steps of:
collecting dried plastic granules in said dried material collector; and
distributing said dried plastic granules to the injection molding machine.
